(19) United States
(12) Patent Application Publication
(10) Pub. No.: US 2020/0231239 A1
(43) Pub. Date: Jul. 23, 2020

(54) FASTENING SYSTEM FOR FASTENING BAGS TO A MOTORCYCLE

(71) Applicant: GIVI S.p.A, Flero (BS) (IT)

(72) Inventor: Giuseppe VISENZI, Brescia (IT)

(73) Assignee: GIVI S.p.A, Flero (BS) (IT)

(21) Appl. No.: 16/634,897

(22) PCT Filed: Aug. 3, 2018
(86) PCT No.: PCT/IB2018/055865

§ 371 Date: Jan. 29, 2020

(30) Foreign Application Priority Data
Aug. 4, 2017 (IT) 102017000090795

(51) Int. Cl. B62J 7/02

(52) U.S. Cl. CPC B62J 7/02

(57) ABSTRACT

A fastening system relates to fastening a bag or a top-box to a support structure integrally connected to a motorcycle. The fastening system allows to fasten a rigid or soft motorcycle bag or a top-box indifferently to the rack structure positioned posteriorly to the saddle of the motorcycle, or to the luggage rack structure, in general consisting of a tubular structure, positioned laterally to the vehicle, providing a simple and effective system for fastening a motorcycle bag indifferently to one or to the other support structure.

### FIELD OF THE INVENTION

The present invention relates to a fastening system for fastening a bag or a top-box to a support structure integrally connected to a motorcycle.

The fastening system according to the present invention allows to fasten a rigid or soft bag or a top-box both to the rack structure positioned posteriorly to the saddle of the motorcycle, and to the luggage rack structure, in general consisting of a tubular structure, positioned laterally to the vehicle.

### STATE OF THE ART

Fastening systems for fastening a top-box, or topcase, to the posterior luggage rack structure of a motorcycle are known in the sector.

In general, these systems comprise a plate that is stably fixed to the rear luggage rack and configured so as to make it possible to fasten a rigid top-box, or topcase to said plate.

In general, these systems provide for the lower surface of the top-box to be provided with fastening means for fastening the top-box to the plate. Such means can comprise one or more pins integral with the top-box and one or more corresponding seats obtained on the plate, and the stability of the connection between the top-box and the plate is assured by the action of a dedicated lock, which is an integral part of the system for fastening the top-box to the support plate that allows removal of the top-box only to the user in possession of the necessary key.

However, these known systems have some drawbacks. One of the main drawbacks of these known fastening systems is that the support plate that is connected to the luggage rack of the motorcycle can allow mounting different top-box models, however it cannot be fastened for example to the tubular structure for supporting the lateral bags.

Known fastening systems do not assure sufficient fastening stability if the lateral bag is hung from the plate, which in turn was not designed to be connected to said tubular structure.

Moreover, these fastening systems conceived to fasten a top-box to a support plate in turn stably connected to the central luggage rack structure of a motorcycle, would not allow a convenient and secure detachment of the bag from the plate itself if this said plate were in the vertical position because it is connected to the lateral tubular luggage rack structure of a motorcycle. This is because known fastening systems are conceived to fasten the top-box to the luggage rack setting the top-box itself down on the support plate, the top-box being thus supported by the plate in the operations of positioning and fastening, as well as of unfastening and removing, the top-box itself to/from the support plate.

An additional disadvantage of known fastening systems is that generally the support plate that is fixed to the luggage rack structure of the motorcycle is configured to allow fastening a specific top-box model. As stated, the support plate is specifically designed to house fastening means, or it is itself provided with fastening means, which find corresponding means directly obtained on the lower surface of the top-box itself.

For these reasons, if it is desired or if it becomes necessary for any reason to replace the top-box, the entire fastening system will necessarily have to be replaced, including the support plate fixed to the luggage rack of the vehicle.

### SUMMARY OF THE INVENTION

The specific task of the invention therefore is to overcome the drawbacks left unresolved by known fastening systems.

Within this task, a purpose of the present invention in particular is to provide a new fastening system for fastening a rigid or soft bag or a top-box to a support structure integrally connected with a motorcycle, which allows fastening a bag or a top-box to a support structure integrally connected with a motorcycle, both if said support structure consists of the central luggage rack of the motorcycle, and if said support structure consists of the tubular structure for lateral bags, allowing a simple and secure fastening even if the support plate is positioned vertically because it is connected to the lateral bag rack structure of a motorcycle.

An additional purpose of the present invention is to provide a fastening system for fastening a bag or of a top-box to a support structure integrally connected with a motorcycle, which allows fixing both top-boxes or rigid bags, made of plastic material or of metallic material, and soft bags, made of fabric, in general synthetic fabric or polymeric materials.

The fastening system according to the present invention makes it possible to fasten to the support plate a different type or model of bag or of top-box without having to replace the entire fastening system, but being able to replace only the bag or top-box. This task, as well as the aforementioned purposes and others that will become more readily apparent hereafter, are achieved by a fastening system for fastening a bag or a top-box to a support structure integrally connected with a motorcycle, according to claim 1.

Further features of the fastening system according to the present invention are set forth in the dependent claims.

### LIST OF FIGURES

The characteristics and advantages of the fastening system for fastening a bag or of a top-box to a support structure integrally connected with a motorcycle, according to the present invention will become more readily apparent from the following detailed description, provided by way of non-limiting example, referred to the accompanying schematic drawings in which:

FIG. 1 shows a perspective view of the components of the fastening system according to the present invention;

FIGS. 2A and 2B show an exploded and, respectively, assembled perspective view of the support plate that is a part of the fastening system according to the present invention fixed to a support structure for lateral bags of a motorcycle;

FIGS. 3A and 3B show an exploded and, respectively, assembled perspective view of the support plate that is a part of the fastening system according to the present invention fixed to a support structure for a central top-box of a motorcycle;

FIGS. 4A, 4B and 4C show different steps of fastening a bag to a support plate by means of the fastening system according to the present invention;

FIGS. 5A and 5B show different steps of operation of the closure device that is a part of the fastening system according to the present invention;

FIG. 6 shows an exploded view of the closing system that is a part of the fastening system according to the present invention.

### DETAILED DESCRIPTION OF THE INVENTION

The accompanying figures show overall views and views of the details and exploded views of the individual elements that constitute the fastening system for fastening a bag or a top-box to a support structure integrally connected with a motorcycle according to the present invention.

With particular reference to the accompanying figures, the fastening system 10 according to the present invention for fastening a bag 1 or a top-box to a support structure 6, 7 integrally connected with a motorcycle comprises a plate 3 configured to be stably fixed to a support structure integrally connected with the motorcycle, and a counter-plate 4 stably fixed to said bag 1 or top-box to be fastened to the support structure of the motorcycle.

Said counter-plate can be removably associated to the plate 3, and for this purpose the counter-plate 4 comprises a plurality of fastening teeth 41, while at the same time the plate 3 will comprise a corresponding number of housing seats 31.

More in particular, each of the housing seats 31 is configured to house one of said fastening teeth 41, and each of them will comprise for this purpose at least one insertion segment 31a configured to allow the insertion of one of said teeth 41 following an approach movement along a direction substantially orthogonal to the surfaces of the plates intended to face coupled plates, of the counter-plate 4 to the plate 3.

In addition, each of said housing seats 31 will comprise a sliding segment 31b for fastening said tooth 41 in said seat 31, following a translating movement of said counter-plate 4 with respect to said plate 3, which as stated will previously have been fixed to the support structure 6, 7 of the motorcycle, and hence it is assumed to be in a fixed position.

The fastening system 10 according to the present invention further comprises at least one closure device 50 able to be actuated by the user and configured for selectively preventing the relative translation movements of said counter-plate 4 with respect to said plate 3.

Advantageously, according to a preferred embodiment of the invention described herein by way of example, the counter-plate 4 is made of plastic material or of other suitable, light, resistant material suited for obtaining a moulded piece, and it is fixed to the motorcycle bag 1 by screws or rivets, thus becoming an integral part of the bag 1.

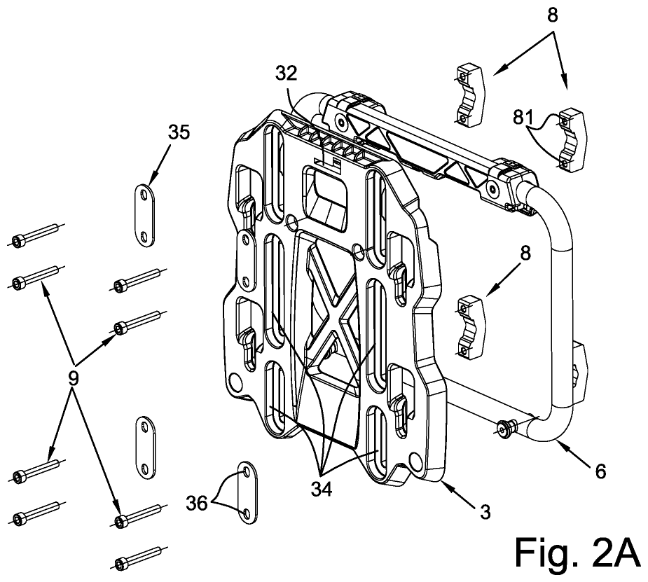

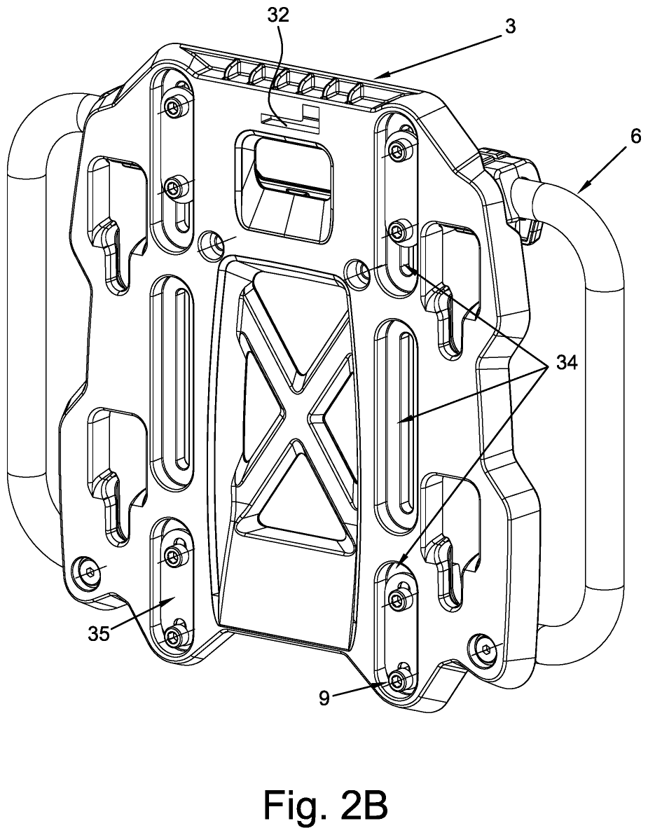

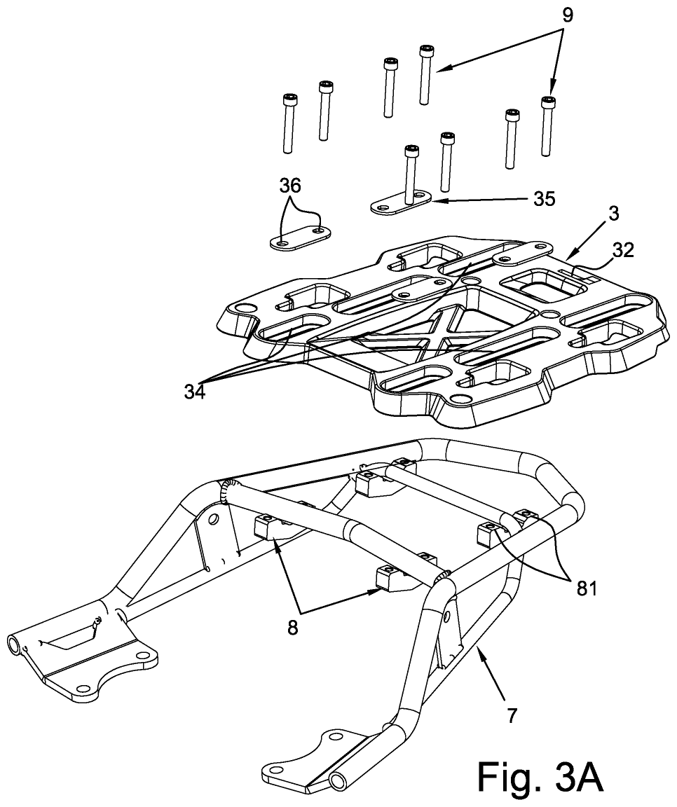

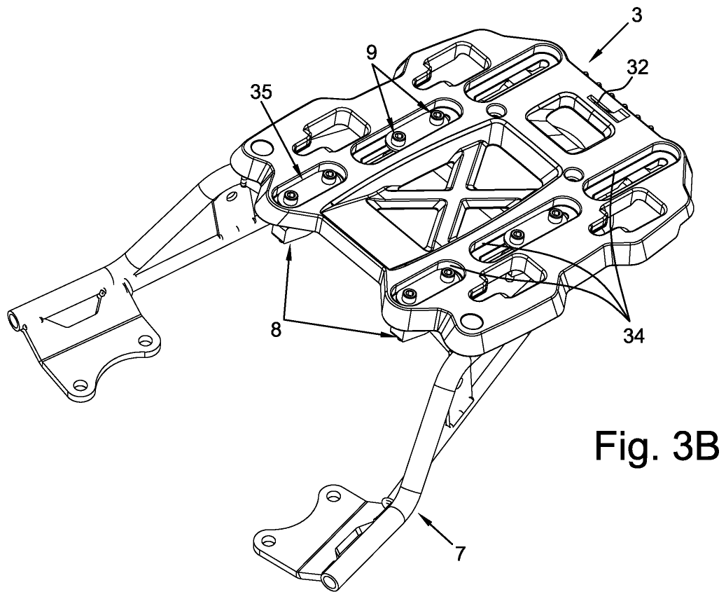

The plate 3, also preferably but not necessarily made of plastic material, is configured to be fixed to the support structure for the lateral bags of a motor cycle, as shown for example in FIGS. 2A and 2B where it is designated with the reference numeral 6, or the central luggage rack of the motorcycle, shown for example in FIGS. 3A and 3B where it is designated with the reference numeral 7.

For the purpose, on the plate 3 is obtained a plurality of shaped guides 34 within which can be housed holed platelets 35.

In the holes 36 of said holed platelets 35 can advantageously be inserted metric screws 9 which are screwed in the threaded holes 81 obtained on suitable clevises 8 configured to encompass said support structure 6, 7 or on nuts housed within said clevises 8.

Advantageously, said support structure 6, 7 comprises in general at least one tubular segment, and said clevises 8 are configured to encompass said tubular segment.

The counter-plate 4 is advantageously fixed to the bag 1 by means of screws or rivets which pass through the holes 42.

The operation of the fastening system 10 according to the present invention is as follows.

The counter-plate 4, which as stated is integrally connected with a bag 1, is coupled to the plate 3 through the insertion of the fastening teeth 41 within the corresponding housing seats 31 present on the plate 3.

Preferably, according to the embodiment shown in the accompanying figures, said fastening teeth 41 are four in number.

This contributes to make more stable the fastening of the bag to the support structure of the motor vehicle, and this provides a particular advantage above all when the bag is fastened to the support structure for lateral luggage of the motorcycle, situation in which the bag 1 is substantially “hung” from the support structure 6.

Advantageously, said fastening teeth 41 are obtained in a single piece on the counter-plate 4.

Once the fastening teeth 41 are inserted into the first housing segment 31a of the housing seat 31, fastening is completed moving the bag 1 so as to obtain a relative translation of the counter-plate 4 with respect to the plate 3 to bring the fastening teeth 41 to the end stop in the sliding segment 31b of the housing seats 31.

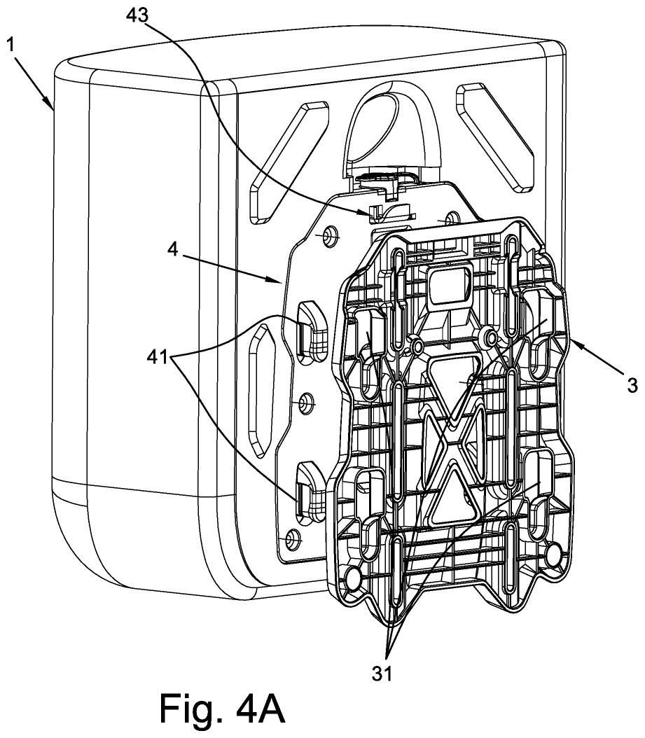

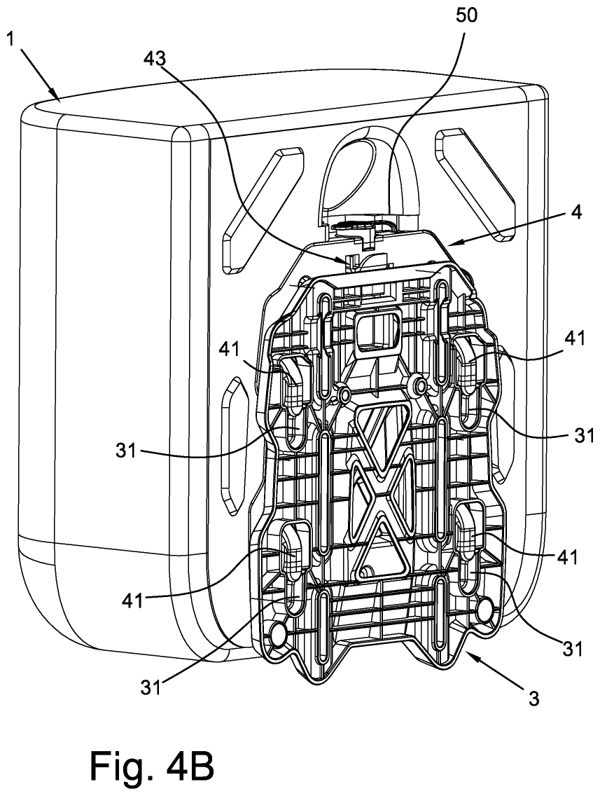

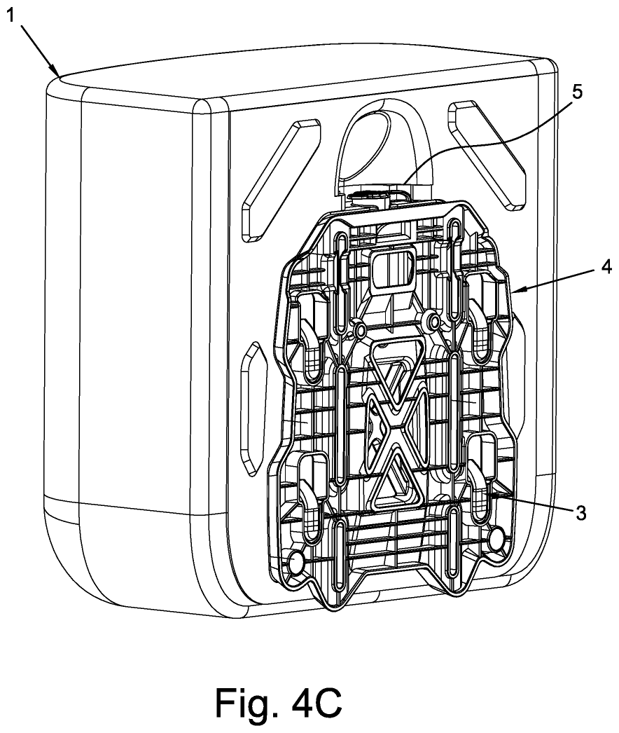

FIGS. 4A, 4B and 4C show various steps of the fastening of the counter-plate 4, to which is connected the bag 1, to the plate 3. In these figures the plate 3 is oriented vertically in space, as occurs in the case of fastening to the support structure for lateral bags 6 of a motorcycle.

Advantageously, said fastening teeth 41 are configured “like a hook”, with a first segment 41a that joins to said counter-plate 4 and projects from it in a direction substantially orthogonal to the plane in which the counter-plate 4 lies, and a second segment 41b that extends substantially parallel to the plane in which said counter-plate 4 lies.

Preferably, each of said housing seats 31 has an insertion segment 31a having, on the plane defined by said plate 3, a substantially quadrangular or similar profile, and a sliding segment 31b that joins to said insertion segment 31a and that has, on the plane defined by said plate 3, a substantially elongated profile having a width suitable for allowing the sliding of said tooth 41 in said sliding segment 31b in order to carry out the fastening of the counter-plate 4 and of the plate 3 following the relative translation movement of said counter-plate 4 with respect to said plate 3.

To assure that the counter-plate 4, to which the bag 1 is connected, is not uncoupled from the plate 3 thus with the risk that the bag may become unfastened from the motorcycle the fastening system 10 according to the present invention comprises, preferably on the counter-plate 4, a closure device 50 able to be actuated by the user.

In more detail, said closure device 50 is configured so as to selectively prevent the relative translation movements of said counter-plate 4 with respect to said plate 3.

Preventing the sliding of the counter-plate 4 with respect to the plate 3, the fastening teeth 41 are prevented from sliding within said sliding segments 31b of the housing seats 31, moving to the housing segments 31a, condition in which the counter-plates 4 can be uncoupled from the plate 3.

The closure device 50 comprises a lock cylinder 51a inserted in a containment cylinder 59 configured to be inserted in a dedicated closing case 59a, said device comprising a dedicated key 51 for the actuation of the lock cylinder 51a.

Advantageously, the key 51, through the lock cylinder 51a, actuates a locking element 52, or sub-lock, so that by rotating the key by 90° one equally obtains a 90° rotation of the locking element 52, or sub-lock, preferably shaped as a platelet and comprising a locking tooth 53 that protrudes from said locking element in a direction substantially perpendicular to the plane in which said locking element 52 lies.

The coupling between the counter-plate 4 and the plate 3 is allowed when the key 51 of the closure device 50 is in open position, for example corresponding to a condition of the key parallel to the plates, so that the locking element 52 is fully within a closing case 59a, as will be better described hereafter.

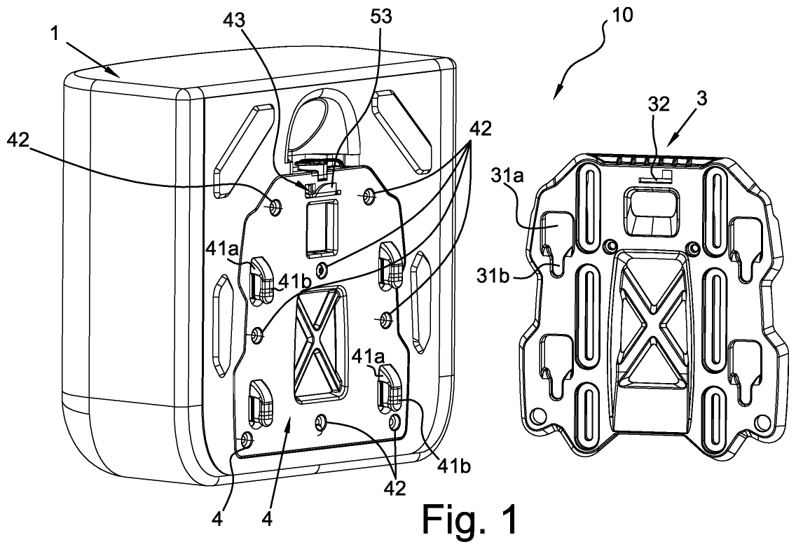

On the counter-plate 4 is obtained an opening 43 that allows the movement of the locking element 52 which, actuated by the key 51, can be brought in the position visible for example in FIG. 1 in which it projects from counter-plate 4 through the opening 43, as better described hereafter.

After coupling the two plates to each other, with the described procedure, it is then possible to rotate the key 51 in closed position, for example corresponding to a condition with the key perpendicular to the plates. In this way, the locking element 52 rotate entering into the corresponding opening 32 obtained on the plate 3 and thanks to the interference between the locking tooth 53 and the plate 3 it is not possible to separate the counter-plate 4, and hence the bag 1, from the plate 3.

To unfasten the bag 1 from the plate 3 and hence from the vehicle, it is necessary to rotate the key 51 in the open position and hence to move the bag upwards so as to make the counter-plate 4 translate with respect to the plate 3 until the fastening teeth 41 are at said housing segments 31a of said housing seats 31.

At this point, the bag 1 can be unfastened from the plate 3 by means of a movement away in a direction substantially orthogonal to the plate 3 of the bag, thus causing the counter-plate 4 to move away from the plate 3.

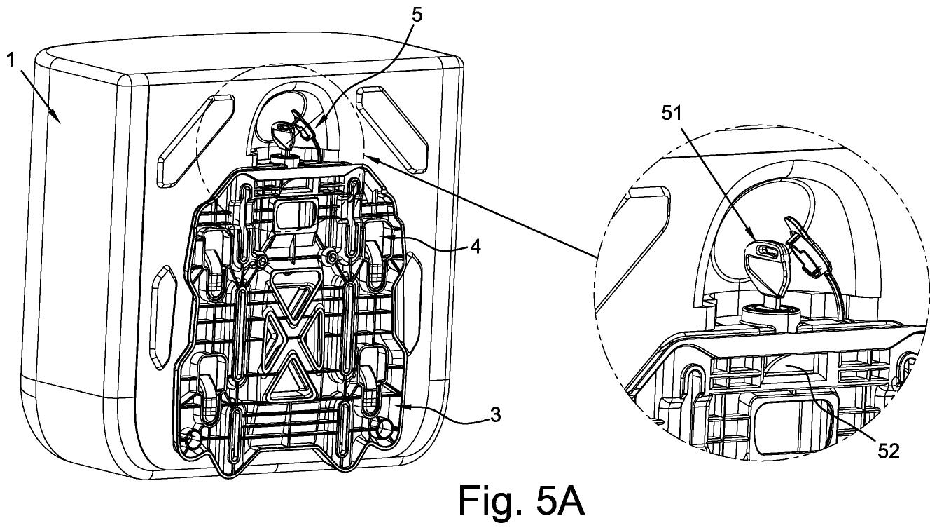

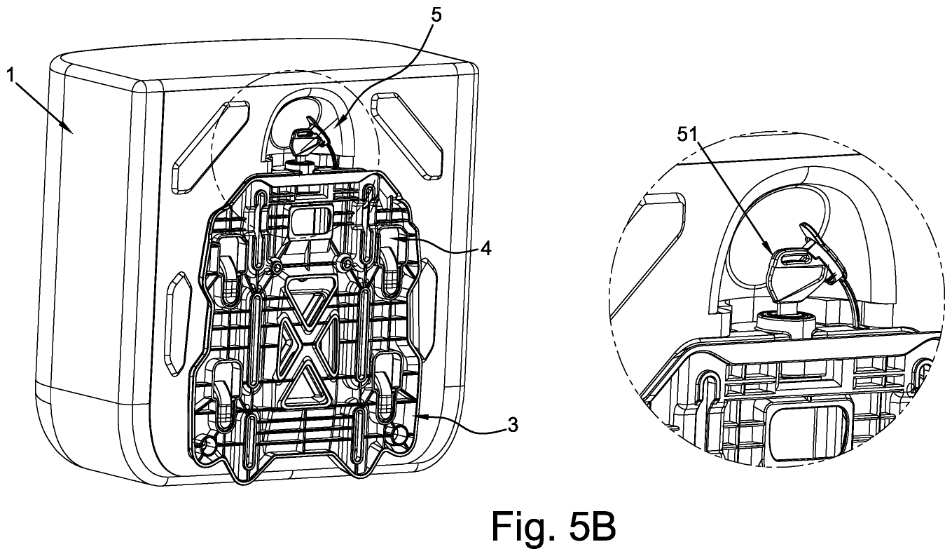

FIG. 5A shows the fastening system 10 according to the present invention with the key 51 of the locking device in closed position, while FIG. 5B shows the condition in which the key 51 is in the open position.

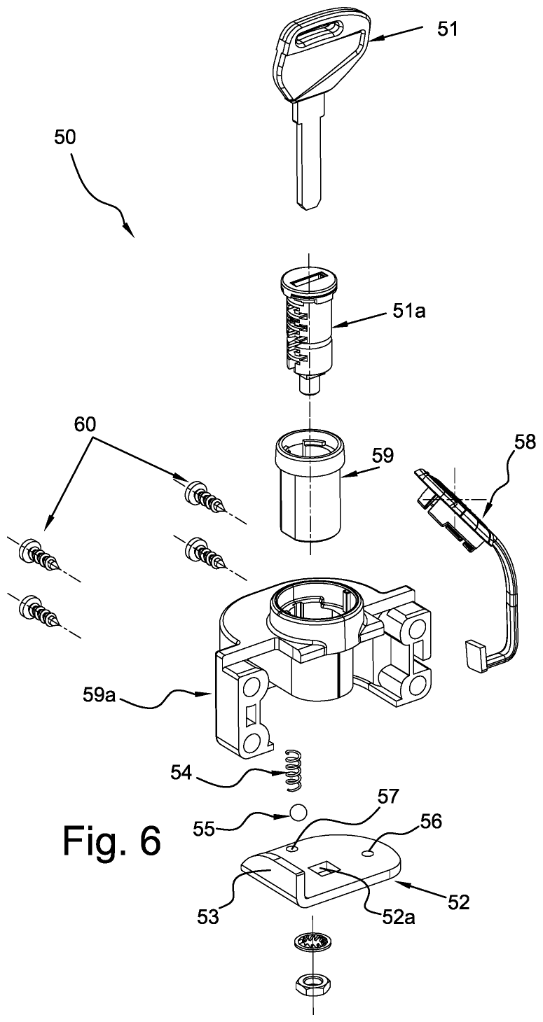

With particular reference to the exploded view of FIG. 6, advantageously the fastening system according to the present invention comprises a closure system 50 which in turn comprises a positioning system for positioning the locking element 52 comprising locking holes 56, 57 a spring 54 and a locking ball 55.

On the locking element 52 are present two locking holes, a first locking hole 56 and a second locking hole 57, positioned on said locking element 52 so as to be at the ends of a 90° circumference arc centred in the connecting point 52a of said locking element 52 and said lock cylinder 51a so as to constitute end stops for the rotation of said locking element 52 respectively in the closure and opening position of the closure device 50.

In the closed position, the locking ball 55 is thrust by the spring 54, preferably a helical spring, within the first locking hole 56 thus making the position of the key 51 stable in closure. Rotating the key 51, the ball 55 slides along the inner face of the locking element 52 until the ball 55, thrust by the spring 54, does not fall into the second locking hole 57 thus making the position of the key 51 stable in opening. Advantageously, an anti-dust cap 58 is provided to be embedded on the latch of the lock cylinder 51a so that, once the key 51 is removed from the cylinder, dirt cannot enter into the lock, thus making it difficult or impossible to insert the key and/or to open/close the system.

All the components of the closure device 50 are preferably assembled inside a closing case 59a which is fixed to the counter-plate 4 through a plurality of screws 60.

Said closing case 59a also performs the function of preserving the closing mechanism from the entry of dirt that could compromise its operation.

From the above description, the features of the fastening system for fastening a bag or a top-box to a support structure integrally connected to a motorcycle are clear, as are clear the related advantages.

In addition, it is understood that the fastening system according to the present invention is susceptible to many modifications and variants, all within the scope of protection identified by the claims.

Moreover, all the details and materials indicated by way of example can be replaced by technically equivalent elements.

1. A fastening system for fastening a bag or a top-box to a support structure integrally connected to a motorcycle, comprising a plate configured to be stably fixed to said support structure integrally connected to the motorcycle, a counter-plate stably fixed to a bag or top-box and able to be removably associated with said plate, wherein said counter-plate comprises a plurality of fastening teeth and said plate comprises a corresponding number of housing seats which are each configured to receive one of said fastening teeth, said housing seats each comprising an insertion segment configured to allow the insertion of a corresponding tooth following a substantially orthogonal approach movement of the counter-plate to the plate, and a sliding segment for fastening said tooth in the corresponding housing seat following the relative translation of said counter-plate with respect to said plate, said counter-plate further comprising at least one closure device able to be actuated by the user and adapted to selectively prevent the relative translation movements of said counter-plate with respect to said plate, said closure device in turn comprising a lock cylinder inserted in a containment cylinder in turn inserted in a dedicated closing case, said closure device also comprising a dedicated key for the actuation of said lock cylinder and a locking element connected to said lock cylinder and rotatable by means of a rotation of said key, said locking element being configured to be inserted into an opening obtained on said plate and configured to house said locking element when said counter-plate and said plate are coupled and said key of said locking device is brought into closure position.

2. The fastening system according to claim 1, wherein said closure device can be actuated by the user between an open position that allows the relative translation movement of the counter-plate with respect to the plate so that said fastening teeth can be withdrawn from said housing seats allowing the separation of said counter-plate from said plate, and a closed position in which the relative movement of said counter-plate with respect to said plate is prevented, and said teeth are stably held in said seats and the counter-plate is stably associated with said plate.

3. The fastening system according to claim 2, wherein said fastening teeth are configured like a hook, with a first segment that joins to said counter-plate and projects from it in a direction substantially orthogonal to the plane in which the counter-plate lies, and a second segment that extends substantially parallel to the plane in which said counter-plate lies.

4. The fastening system according to claim 3, wherein each of said housing seats has an insertion segment having, on the plane defined by said plate, a substantially quadrangular profile, and a sliding segment that joins to said insertion segment and that has, on the plane defined by said plate, a substantially elongated profile having a width suitable for allowing the sliding of said tooth in said sliding segment in order to carry out the fastening of the counter-plate and of the plate following the relative translation of said counter-plate with respect to said plate.

5. The fastening system according to claim 1, wherein said fastening teeth, and said housing seats, are four in number.

6. The fastening system according to claim 1, wherein each of said fastening teeth has said second segment oriented according to the same direction and facing the same way.

7. The fastening system according to claim 1, wherein said counter-plate is fixed to said bag by means of a plurality of screws or rivets.

8. The fastening system according to claim 1, wherein said locking element in turn comprises a locking tooth that projects from said locking element in a direction orthogonal to the plane in which said locking element lies and in that said plate comprises an opening configured so as to receive said locking element when said counter-plate and said plate are coupled and said key of said locking device is brought into closure position, so that said locking tooth interferes with said plate preventing the decoupling of the counter-plate from the plate.

9. The fastening system according to claim 1, wherein said closure device further comprises a positioning system for positioning the locking element comprising at least one first locking hole and a second locking hole obtained on said locking element and positioned so as to constitute end stops for the rotation of said locking element in the closed and open position, respectively, of the closure device, said positioning system also comprising at least one locking ball configured to selectively interfere with said first and second locking holes under the thrust of a spring.
